(19) United States
(12) Patent Application Publication
(10) Pub. No.: US 2006/0094586 A1
(43) Pub. Date: May 4, 2006

(54) Dielectric ceramic composition and method

(76) Inventors: Qi Tan, Albuquerque, NM (US); Jeffrey R. Jacquin, Albuquerque, NM (US)

Correspondence Address: DANIEL J. DENEUFBOURG;CTS CORPORATION, 171 COVINGTON DRIVE, BLOOMINGDALE, IL, 60108, US

(21) Appl. No.: 10/978,588

(22) Filed: Nov. 1, 2004

(51) Int. Cl. C04B 35/478

(52) U.S. Cl. 501/136

(57) ABSTRACT

Multiphase metal oxide ceramic compositions suitable for use in microwave band filters for telecommunications equipment are composites of metal oxides which comprise, on an elemental weight basis, about 42 to about 50% aluminum, about 2.5 to about 6% titanium, about 0.05 to about 1.5% niobium, about 0.04 to about 1% barium, about 0.03 to about 0.7% zirconium, about 0.01 to about 0.3% manganese, up to about 2.5% nickel, and up to about 4% zinc, wherein the aluminum and titanium are present in the composition, as metal oxides, in an elemental weight ratio of Al:Ti in the range of about 8:1 to about 17:1. The ceramic compositions have a resonant frequency, f, in the range of about 2.4 to about 10 GHz, a quality factor, Q, of at least about 4000, a dielectric constant, K, in the range of about 10 to about 15, and a temperature coefficient of resonant frequency, T_{f} in the range of about −20 ppm to about +20 ppm. Metal oxide powder compositions useful for preparing the dielectric ceramic compositions and a method of making the ceramic compositions are also described.

### FIELD OF THE INVENTION

This invention relates generally to ceramic materials, and particularly to alumina/titanium dioxide-based dielectric ceramic materials suitable for microwave filter applications. This invention also relates to methods of manufacturing alumina/titanium dioxide-based ceramic materials suitable for microwave filter applications.

### BACKGROUND OF THE INVENTION

Microwave systems used in the telecommunications industry and for radar systems are required to operate in specific bands of microwave frequency for specific applications. Microwave bands for telecommunications and radar typically are within the frequency range of about 300 MHz to about 30 GHz. For example, mobile phone networks typically operate in the range of about 900 MHz to about 1800 MHz (1.8 GHz), whereas ultra high frequency television broadcasts operate in the range of about 470 to about 870 MHz, and satellite television broadcasts at about 4 GHz.

In order to prevent interference among different mobile phone networks, television broadcasts, radar, and other microwave broadcasts, each type of microwave generating equipment is required to operate within specific, narrowly defined ranges of frequency or bandwidth. Typically, the relatively narrow bandwidth is obtained by filtering a broader frequency band created by a microwave generator. By far the most important of such microwave resonant filters are ceramic materials. Ceramic materials suitable for use as microwave filters for a specified application are selected based upon a number of physical and electrical properties of the ceramic materials. Among the most important properties for selecting a ceramic material for use in a specified microwave communication or radar device are: dielectric constant, K (also known as relative permittivity, Fd); the quality factor, Q; the resonant frequency, f; and the temperature coefficient of resonant frequency, T_{f} (also known as τ_{f}).

The dielectric constant, K, of a material relates to the capacitance of the material (the ability to store electrical energy). The dielectric constant of a material, at least in part, determines the size of the filter necessary for a given application. Filter size is inversely related to the dielectric constant of the filter material. Relatively small filters can be fashioned from relatively high dielectric constant materials, whereas filter size must be increased as the dielectric constant is decreased. While very high dielectric constant materials might be considered desirable for miniaturization of equipment, practical considerations of design, as well as other physical properties of the ceramic filter material, such as the Q value and temperature coefficient of resonant frequency, will often dictate a choice of a relatively low dielectric constant material. Ceramic materials having a dielectric constant, K, in the range of about 10 to about 100 are particularly useful in a variety of wireless telecommunications applications.

The quality factor, Q, is a measure of the efficiency of a microwave system, which relates to the degree of power loss of the system. A quality factor can be defined for a whole system, a device, or for specific components or groups of components within a device or system. As used herein and in the appended claims, the Q value refers to a quality factor for a ceramic material in the form of a disc having a diameter of about 1.1 to about 1.33 inches and a thickness of about 0.5 inches. Q is a dimensionless factor equal to 1/tan δ, where δ is the loss angle. In an ideal capacitor, the phase of the current will lead the phase of the voltage by 90 degrees, whereas in all real capacitors, a power loss occurs, which is manifested in a phase deviation from the ideal 90 degrees. The difference between ideal phase angle (90 degrees) and the measured phase angle in an actual capacitor is equal to δ. As δ decreases, 1/tan δ increases; therefore, higher values of Q represent smaller values of δ, and thus indicate higher power efficiency for a capacitor.

Experimentally, Q can also be determined by the shape of the frequency resonance peak in a graph of frequency versus signal amplitude. Typically, there is a peak in transmitted signal amplitude at the resonant frequency, and the distribution of amplitude versus frequency has a finite width. By convention, the “bandwidth” is defined as the width of the frequency distribution at one half of the maximum amplitude. The peak frequency (resonant frequency, f) divided by the bandwidth is equal to Q. Thus, high Q values indicate narrow bandwidths.

The resonant frequency, f, is the peak frequency of the microwave energy that is transmitted (i.e., not blocked) by the filter. Because power losses generally increase with increasing frequency, the Q value is dependent on the resonant frequency of the filter, and the value of Q is properly reported in combination with the resonant frequency (often the frequency is listed in parentheses after Q). For convenience, a factor which is the product of Q multiplied by the resonant frequency in GHz (hereinafter “frequency-times-quality factor” or Qf, in units of GHz) is often utilized in place of, or in addition to reporting the Q and frequency.

For many ceramic filter materials, f will vary with the temperature of the filter. The temperature coefficient of resonant frequency, T_{f}, represents the change in f per degree C. increase in temperature, reported in parts per million (ppm); i.e., the number of Hz by which the frequency changes when the temperature is increased one degree C., divided by f in MHz. It is particularly desirable for T_{f} to be as close to zero as possible; however, in practice, a T_{f} in the range of about −20 to about +20 ppm is acceptable.

In recent years, the range of frequencies used in electronic communications has expanded so that higher frequencies, i.e., those in the microwave range, are increasingly utilized. One of the demands of the telecommunications industry is a dielectric filter having a resonant frequency at about 2.4 GHz and above, where low dielectric constant and high quality factors are required. A major challenge in modern microwave dielectric ceramic filter materials research is the development of near zero T_{f} materials. The achievement of relatively low T_{f} in filter materials having a dielectric constant in the low-dielectric constant range of about 10-15, a resonant frequency of 2.4 GHz or greater, and a high Q factor (4000 or greater) has been a particular challenge.

Conventional dielectric ceramic materials made of alumina or modified alumina do not exhibit sufficiently high Q factor values along with sufficiently low temperature coefficients for satisfactory use as filters and resonators in the microwave frequency band. Additionally, these conventional materials are limited in that they require sintering at relatively high peak soak temperatures of about 1550° C. The peak soak temperature is the maximum (peak) temperature achieved during sintering; it is at this temperature that the material remains (soaks) for a period of time. Alumina/titanium dioxide-based dielectric ceramic compositions have found use as filters and resonators at frequencies in the range of about 2 GHz and above. Such materials are described in U.S. Pat. No. 6,242,376 (Jacquin et al.). However, achieving a very high resonant frequency (i.e., f in the range of about 2.4 to about 10 GHz), while also maintaining low T_{f}, high Q, and a low dielectric constant (i.e., about 10-15) has been an elusive goal.

Thus, there is thus an ongoing need for high frequency ceramic microwave filter materials having a very high resonant frequency (i.e., f in the range of about 2.4 to about 10 GHz), a relatively low temperature coefficient of resonant frequency (i.e., T_{f} in the range of about Å 20 ppm), a relatively high quality factor (a Q of at least about 4000), and a relatively low dielectric constant (i.e., K in the range of about 10 to about 15). The present invention fulfills this need.

### SUMMARY OF THE INVENTION

A dielectric ceramic composition of the present invention is a multiphase ceramic material comprising an alumina and titanium dioxide base and including metal oxide additives including niobium oxide (Nb₂O₅), barium zirconate (BaZrO₃), manganese oxide (Mn₂O₃), and optionally nickel oxide (NiO) and/or zinc oxide (ZnO). The dielectric ceramic compositions of the invention typically have a resonant frequency, f in the range of about 2.4 to about 10 GHz; a quality factor, Q, of at least about 4000; a dielectric constant, K, in the range of about 10 to about 15; and a temperature coefficient of resonant frequency, T_{f}, in the range of about −20 ppm to about +20 ppm. These dielectric ceramic compositions are well suited for the manufacture of microwave filters for telecommunication systems and devices, such as cordless telephones and wireless cable television applications.

The present ceramic material is a composite of metal oxides, which comprises, on an elemental weight basis, about 42 to about 50% aluminum, about 2.5 to about 6% titanium, about 0.05 to about 1.5% niobium, about 0.04 to about 1% barium, about 0.03 to about 0.7% zirconium, about 0.01 to about 0.3% manganese, up to about 2.5% nickel, and up to about 4% zinc, wherein the aluminum and titanium are present in the composition (as oxides) in an elemental weight ratio of Al:Ti in the range of about 8:1 to about 17:1.

In one preferred embodiment, the dielectric ceramic composition is doped with nickel oxide in an amount sufficient to provide a nickel content of at least about 0.05 weight % in the ceramic material, on an elemental weight basis. In another preferred embodiment, the dielectric ceramic compositions are doped with zinc oxide in an amount sufficient to provide a zinc content of at least about 0.05 weight % in the ceramic material, on an elemental weight basis.

Another aspect of the present invention is a metal oxide powder composition suitable for preparation of a metal oxide-based dielectric ceramic composition. The powder is prepared by combining, on a total metal oxide weight basis, about 80 to about 95% Al₂O₃, about 4 to about 10% TiO₂, about 0.1 to about 2% Nb₂O₅, about 0.1 to about 2% BaZrO₃, about 0.01 to about 0.4% Mn₂O₃, up to about 3% NiO, and up to about 5% ZnO, wherein the Al₂O₃ and the TiO₂ are present in the composition in a weight ratio of Al₂O₃:TiO₂ in the range of about 9:1 to about 19:1. The metal oxides are ground together into a substantially homogeneous powder. A binder, a dispersant, and/or other additives can be included in the mixture, if desired. The powder compositions are useful for preparing multiphase dielectric ceramic compositions of the invention. Optionally, the powder can be calcined.

In another aspect, the present invention provides a method of manufacturing a multiphase metal oxide dielectric ceramic composition having a resonant frequency, f, in the range of about 2.4 to about 10 GHz; a quality factor, Q, of at least about 4000; a dielectric constant, K, in the range of about 10 to about 15; and a temperature coefficient of resonant frequency, T_{f}, in the range of about −20 ppm to about +20 ppm.

The method comprises forming a green body from a co-mixture of a binder and a finely divided, substantially homogeneous metal oxide powder composition comprising, on a weight basis, about 80 to about 95% Al₂O₃, about 4 to about 10% TiO₂, about 0.1 to about 2% Nb₂O₅, about 0.1 to about 2% BaZrO₃ about 0.01 to about 0.4% Mn₂O₃, up to about 3% NiO, and up to about 5% ZnO, wherein the Al₂O₃ and the TiO₂ are present in the composition in a weight ratio of Al₂O₃:TiO₂ in the range of about 9:1 to about 19:1. The green body is then sintered at a temperature in the range of about 1300 to about 1500° C., for a time period in the range of about 3 to about 5 hours to form a ceramic material. The resultant ceramic material is thereafter gradually cooled. Optionally, the metal oxide powder composition can be calcined at a temperature in the range of about 1000 to about 1250° C. for a time period in the range of about 2 to about 6 hours prior to forming the green body.

### DETAILED DESCRIPTION OF PREFERRED EMBODIMENTS

The term “sintering” and grammatical variations thereof, as used herein and in the appended claims, refers to a process of heating a molded object composed of a mixed or calcined particulate material comprising metal oxides, or other inorganic compounds (i.e., a “green body”), typically at a temperature below the melting point of the material, and for a time period sufficient to form a coherent, fused, solid mass (i.e., a ceramic material). Sintering (alternatively referred to in the art as “firing”) typically is accompanied by an increase in density and a concomitant decrease in dimensional size relative to the density and size of the green body.

A green body is typically formed by applying pressure to a mixture of metal oxides in a mold or die. The pressure results in the formation of a friable solid object. Binders such as polyvinyl alcohol (PVA), and plasticizers such as polyethylene glycol (PEG), for example, can be added to the metal oxide mixture to improve the binding and formability of the green body, if desired. The sintering process converts the friable green body into a relatively hard, ceramic material, and any organic components, such as binder and plasticizer, are typically burned off during the sintering process. In many cases, the green body is held at a temperature of at least about 500° C. to burn off the organic materials before bringing the material to the sintering temperature (generally at least about 1300° C.).

As used herein and in the appended claims, the terms “calcine,” “calcining,” “calcination” and grammatical variations thereof, refer to a process of heating a particulate substance below its fusion or melting point but at a temperature sufficient to effect a chemical change in one or more components of the material, such as to drive off carbon dioxide from a metal carbonate to form a metal oxide. Generally, calcining also leads to a change in the number of material phases in a mixed-metal oxide composition. For example, a powdered mixture of alumina, titanium oxide, barium zirconate, niobium oxide, and manganese oxide initially contains five distinct phases, one for each individual compound in the mixture. During calcination, initially separate metal oxide phases will typically merge together into one or more complex, mixed-metal oxide phase, in addition to the distinct metal oxide phases of the starting mixture. The terms “calcinated powder” and “calcinated particulate material” as used herein and in the appended claims refers to a powder or particulate material that has been subjected to a calcination process. Typical calcining temperatures are in the range of about 1000° C. to about 1250° C.

As used herein and in the appended claims, the term “substantially homogeneous” when used in reference to mixtures of powdered metal oxides and metal salts, means that the powders have a similar particle size distribution and have been mixed together in such as way that, on a macroscopic scale, compositional analyses of random samples of the mixture will result in substantially the same compositional result, which is equivalent to the average composition of all of the metal oxide and metal salt components in the mixture, in proportion to their amounts in the mixture.

The term “mesh” as used herein and in the appended claims refers to a maximum particle size based on material that will pass through an American Standard Sieve Series sieve of the specified mesh size. For example, a powdered material having particle size of 40 mesh means that the powder will pass substantially completely through an American Standard Sieve rated as 40 mesh, i.e., having a sieve opening of about 0.42 millimeters (420 micrometers).

A metal oxide dielectric ceramic composition of the present invention is a multiphase composite containing oxides of aluminum, titanium, niobium, barium, zirconium, manganese, and optionally nickel and/or zinc. The dielectric ceramic comprises, on an elemental weight basis, about 42 to about 50% aluminum (preferably about 47 to about 50% Al), about 2.5 to about 6% titanium (preferably about 3.5 to about 4% Ti), about 0.05 to about 1.5% niobium (preferably about 0.1 to about 0.5% Nb), about 0.04 to about 1% barium (preferably about 0.05 to about 0.6% Ba), about 0.03 to about 0.7% zirconium (preferably about 0.04 to about 0.4% Zr), about 0.01 to about 0.3% manganese (preferably about 0.05 to about 0.3% Mn), up to about 2.5% nickel, and up to about 4% zinc. The aluminum and titanium are present in the composition in an elemental weight ratio of Al:Ti in the range of about 8:1 to about 17:1, preferably in the range of about 12:1 to about 14:1.

In order to determine the chemical composition of metal oxide ceramic materials, the weight percentage of each metallic element in a ceramic is determined analytically and the percentage of the corresponding metal oxide is then calculated based on the known formula weight of the oxide. Ceramic compositions are often described by the content of the metal oxides used to prepare the ceramic, (e.g. 80% aluminum oxide, 5% titanium dioxide, 5% barium zirconate). It is understood by those of ordinary skill in the art, however, that metal oxide ceramic materials are frequently complex mixtures of metal oxides, in which the distinct phases of the initial metal oxide mixture have merged, at least partially, to form structures that are not purely one metal oxide or another. For example, a mixture containing barium zirconate and titanium dioxide can partially equilibrate to form regions of barium titanate and zirconium dioxide, in addition to regions or phases that are still predominately titanium dioxide and barium zirconate.

It is generally impractical to directly measure the amount of a metal oxide, per se, such as alumina or titanium dioxide, in a ceramic material. Instead, the quantity of the metallic elements are measured as described above, and the percentage of each oxide in the ceramic is calculated. Accordingly, for convenience, the metal oxide-containing ceramic materials of the present invention are described herein and in the appended claims, by specifying weight percentages of the metallic elements present in the composition. The use of elemental percentages is not meant to imply the presence in the ceramic of the metals in their elemental state, however. It is to be understood that the metals are present in the ceramic compositions as oxides, which can be in pure metal oxide phases and/or mixed metal oxide phases.

In one preferred embodiment, the dielectric ceramic composition is doped with nickel oxide in an amount sufficient to provide a nickel content of at least about 0.05 weight % in the ceramic material, on an elemental weight basis. Preferably, the ceramic composition comprises about 0.05 to about 2% nickel, on an elemental weight basis; more preferably, about 0.05 to about 1%.

In another preferred embodiment, the dielectric ceramic composition is doped with zinc oxide in an amount sufficient to provide a zinc content of at least about 0.05 weight % in the ceramic material, on elemental weight basis. Preferably, the ceramic composition comprises about 0.05 to about 3% zinc, on an elemental weight basis; more preferably, about 0.05 to about 2%.

In yet another preferred embodiment, the dielectric ceramic composition comprises at least about 0.05% nickel and at least about 0.05% zinc, preferably about 0.05 to about 2% nickel and about 0.05 to about 3% zinc; more preferably, about 0.05 to about 1% nickel and about 0.05 to about 2% zinc, on an elemental weight basis.

A particularly preferred dielectric ceramic composition of the invention is a composite of metal oxides which comprises, on an elemental weight basis about 47 to about 50% aluminum, about 3 to about 4% titanium, about 0.1 to about 0.5% niobium, about 0.05 to about 0.6% barium, about 0.04 to about 0.4% zirconium, about 0.05 to about 0.3% manganese, up to about 2% nickel, and up to about 3% zinc; wherein the aluminum and titanium are present in the ceramic composition in an elemental weight ratio of Al:Ti in the range of about 12:1 to about 14:1.

The dielectric ceramic compositions of the invention have a resonant frequency, f, in the range of about 2.4 to about 10 GHz, a quality factor, Q, of at least about 4000, preferably at least about 6000; a dielectric constant, K, in the range of about 10 to about 15, preferably about 10 to about 12; and a temperature coefficient of resonant frequency, T_{f}, in the range of about −20 ppm to about +20 ppm, preferably about −10 to about +10, more preferably about −3 to about +3.

Another aspect of the present invention is a metal oxide powder composition suitable for preparation of a dielectric metal oxide ceramic composition. The powder is a mixture of metal oxides comprising, on a total metal oxide weight basis about 80 to about 95% Al₂O₃ (preferably about 87 to about 94%); about 4 to about 10% TiO₂ (preferably about 5 to about 7%); about 0.1 to about 2% Nb₂O₅ (preferably about 0.25 to about 0.5%); about 0.1 to about 2% BaZrO₃ (preferably about 0.15 to about 1%); about 0.01 to about 0.4% Mn₂O₃ (preferably about 0.05 to about 0.4%); up to about 3% NiO, and up to about 5% ZnO, wherein the Al₂O₃ and the TiO₂ are present in the composition in a weight ratio of Al₂O₃:TiO₂ in the range of about 9:1 to about 19:1, preferably about 14:1 to about 16:1. Preferably, the powder compositions comprise about up to about 2% NiO (more preferably about 0.05 to about 1%), and/or up to about 3% ZnO (more preferably about 0.05 to about 2%). The powder compositions are useful for preparing multiphase dielectric ceramic compositions of the invention.

A particularly preferred metal oxide powder composition of the invention comprises, on a total metal oxide weight basis, about 87 to about 94% Al₂O₃, about 5 to about 7% TiO₂, about 0.2 to about 0.5% Nb₂O₅, about 0.1 to about 1% BaZrO₃, about 0.05 to about 0.4% Mn₂O₃, up to about 2% NiO, and up to about 3% ZnO, wherein the Al₂O₃ and the TiO₂ are present in the composition in a weight ratio of Al₂O₃:TiO₂ in the range of about 14:1 to about 16:1. Preferably, the powder compositions comprise about 0.05 to about 1% NiO, and/or about 0.05 to about 2% ZnO.

The powder compositions of the present invention can be mixtures of metal oxides and salts of metal oxides (e.g., barium zirconate), or can be calcined and comminuted, if necessary, to provide a metal oxide powder containing both pure oxide phases and mixed oxide phases.

The metal oxide powder compositions of the present invention preferably have a median particle size in the range of about 0.01 to about 10 μm, more preferably about 0.1 to about 5 μm, most preferably about 0.2 to about 0.5 μm as determined by laser particle size analysis.

In another aspect, the present invention provides a method of manufacturing a multiphase metal oxide dielectric ceramic composition having a resonant frequency, f, in the range of about 2.4 to about 10 GHz; a quality factor, Q, of at least about 4000; a dielectric constant, K, in the range of about 10 to about 15; and a temperature coefficient of resonant frequency, T_{f}, in the range of about −20 ppm to about +20 ppm.

The method comprises forming a green body from a co-mixture of a binder and a finely divided, substantially homogeneous metal oxide powder composition of the invention; i.e., comprising, on a weight basis, about 80 to about 95% Al₂O₃; about 4 to about 10% TiO₂; about 0.1 to about 2% Nb₂O₅; about 0.1 to about 2% BaZrO₃; about 0.01 to about 0.4% Mn₂O₃; up to about 3% NiO, and up to about 5% ZnO, wherein the Al₂O₃ and the TiO₂ are present in the composition in a weight ratio of Al₂O₃:TiO₂ in the range of about 9:1 to about 19:1. The green body is then sintered at a temperature in the range of about 1300 to about 1500° C., preferably about 1350 to about 1450° C., for a time period in the range of about 3 to about 5 hours to form a ceramic material, which is then gradually cooled. Typically, the resultant ceramic material is cooled in the furnace by simply turning off the heat source. Preferably the ceramic material is gradually cooled to a temperature at which the material can be removed from the sintering furnace without experiencing thermal shock (generally about 50° C. or lower).

The resulting dielectric ceramic composition is suitable for use as in a microwave filter or resonator for telecommunications equipment, such as cordless telephones and wireless cable television.

Optionally, the metal oxide powder composition can be calcined at a temperature in the range of about 1000 to about 1250° C. for a time period in the range of about 2 to about 6 hours prior to forming the green body. The calcined powder can be comminuted, if necessary, so that the calcined mixture has an median particle size in the range of 0.01 to about 10 μm, preferably about 0.1 to about 5 μm, more preferably about 0.2 to about 0.5 μm, as determined by laser particle size analysis.

The metal oxide powder embodiments of the present invention can include additional components such as MnO₂, Bi₂O₃, Li₂O, LiCO₃, as well as SnO₂. Ceramic compositions made from powders containing such additional components will include oxides of bismuth, lithium, and tin, as the case may be. Additionally, the powder compositions can include an organic binder, a surfactant, a plasticizer, and/or other additives useful for converting the powder compositions into ceramic materials.

The metallic elements (e.g., aluminum, titanium, niobium, barium, zirconium, nickel, and zinc) in the ceramic material of the present invention can be present in the form of pure oxide phases such as Al₂O₃, TiO₂, Nb₂O₅, BaO, ZrO₂, Mn₂O₃, NiO, and ZnO, as well as zirconates, titanates and aluminates, for example. It is understood by those of skill in the ceramic arts that such oxides generally are not exclusively present in their pure forms, but rather can exist in complex, mixed structures within the crystal lattices of the various phases of the ceramic material.

The elemental composition of a powder or ceramic composition of the present invention can be determined by any of a number of analytical methods, which are well known in the ceramic, mineral, and analytical chemistry arts. The composition can be analyzed, for example, by optical emission spectroscopy, atomic absorption spectroscopy (AA), x-ray fluorescence spectroscopy, inductively-coupled plasma (ICP), and the like, after appropriate sample preparation. Exemplary descriptions of such techniques can be found in Willard, Merritt, and Dean, Instrumental Methods of Analysis, Fifth Edition, D. Van Nostrand Company, New York (1974), the relevant disclosures of which are incorporated herein by reference. The elemental composition of the ceramic material of the present invention can also be determined by techniques, such as ICP coupled with mass spectrometry (ICP-MS), electron microprobe analysis, wet analytical techniques such as gravimetric analysis, and the like, as is well known in the art.

The dielectric ceramic compositions of the present invention have useful physical and electrical properties, which makes them particularly suitable for use in cordless telephones, wireless cable television systems, and other microwave telecommunications equipment. The ceramic materials have very high resonant frequency in the range of about 2.4 to about 10 GHz, typically about 3.9 to about 5.3 GHz, coupled with a Q of at least about 4000, generally above 6000, to provide a typical Qf of greater than about 30,000 GHz. The ceramics have a dielectric constant in the range of about 10 to about 15, typically about 11 to 13, and a T_{f}, in the range of about −20 ppm to about +20 ppm, typically about −10 to +10. Some ceramic compositions of the invention have a T_{f}, in the range of about −3 to about +3.

The ceramic materials of the present invention can be prepared by standard ceramic manufacturing techniques that are well known in the ceramic arts. Such techniques involve preparation of a green body by compressing, in a suitable die or mold (e.g., a tungsten carbide die), a powdered, optionally calcined, mixture of metal oxides, optionally employing a binder, followed by sintering (i.e., firing) the green body at a temperature below the melting point of the calcined material, but at a sufficiently high temperature to cause the material to form a solid ceramic mass. Preferably, the ceramic material of the present invention, after sintering, has a fired density (FD) in the range of about 3.7 to about 3.98 grams per cubic centimeter.

Preferably, the metal oxide mixture is substantially homogeneous, and is prepared by grinding an aqueous slurry of the metal oxide compounds in a ball mill, or similar apparatus. Preferably, the slurry contains about 40 to about 60% by weight water, more preferably about 50% by weight (i.e., an amount of water equal to about 66% to about 150% of the weight of the metal oxide mixture, more preferably about 100% of the weight of the metal oxide mixture). After grinding to the desired particle size distribution, the resulting mixture will be substantially homogeneous.

The slurry can also include about 0.5 to about 1 percent by weight of a dispersing agent (preferably about 0.2 to about 0.5%) based on the weight of the metal oxides. Suitable dispersing agents include water soluble polymers such as, for example, a polyacrylic acid, a polymethacrylic acid, an acrylic/methacrylic acid copolymer, an acrylamide/acrylic acid copolymer, or an ammonium salt thereof. A preferred dispersing agent is TAMOL® 963 dispersant, available from Rohm and Haas Company, Philadelphia, Pa., which, according to the manufacturer, is an ammonium salt of a polycarboxylic acid.

The resulting slurry is then dried by application of heat, vacuum, or both. The drying preferably is accomplished by placing the comminuted slurry in pans in a forced air convection oven, by spray drying, by heating in an indirectly heated cascading plate drier, by heating in a directly heated cascading plate drier, by heating in a vacuum oven, and the like. The mixture preferably is dried at a temperature in the range of about 100 to about 150° C., more preferably at least about 120° C. Most preferably, the slurry is spray dried. Typically, the dried material has a water content of less than about 0.5 percent by weight.

During the optional calcining step, any remaining water in the mixture may be substantially driven off. Calcining may also effect changes in the oxidation state of the various metal elements in the mixture depending on whether the atmosphere in the calcining furnace is an oxidizing atmosphere, reducing atmosphere, or is oxidatively neutral. Calcining can also result in some compositional mixing of the various metal oxides within individual particles. Preferably, the calcining step is accomplished under an air atmosphere.

Optionally, the resultant calcined powder can be comminuted, if necessary, to obtain a particle size small enough to substantially pass through a 40-60 mesh sieve (i.e., a particle size of not more than about 40 mesh, or not more than about 420 micrometers in diameter). Preferably, the comminuted powder will have a median particle size in the range of about 0.01 to about 10 micrometers, more preferably 0.1 to about 5 micrometers, as determined by a Horiba Model LA9000 laser particle size analyzer.

The mixture of metal oxides and/or the calcined powder can be comminuted, for example, by wet grinding the powder in a ball mill as described above, or by any other expedient method for achieving the desired particle size distribution. Grinding media useful for wet grinding the calcined material include alumina and zirconia grinding media. Preferably a zirconia grinding medium is used, more preferably a magnesium oxide or yttrium oxide stabilized zirconium oxide grinding medium, most preferably a magnesium oxide stabilized zirconium oxide grinding medium.

A green body can be fashioned from the powder by applying pressure to the mixture in a die or mold, as is well known in the ceramic arts. An organic binder such as PVA, and the like, and/or water, can be included in the powder composition to increase adhesion of the particles and increase the mechanical strength and dimensional integrity of the green body. Surfactants and other additives can be included, if desired, to improve the packing efficiency of the powders in the green body. The binder, plasticizer, and surfactants, when present, conveniently can be added to the water during the wet grinding process. Upon drying, these additives remain associated with the dried powder. Typically, a force in the range of about 5 to about 20 tons is applied to a quantity of powder in a die or mold for a time period in the range of about 10 to about 15 seconds to form the green body, utilizing, for example, a hydraulic press.

Preferably, the binder is present in the green body in an amount in the range of about 1 to about 6 percent by weight, based on the weight of the green body. Preferred binders include one or more compounds selected from PVA, carboxymethyl cellulose, starch, gelatine, a water soluble acrylic resin, and the like. Most preferably the binder is PVA. Binders suitable for use in ceramic processing are well known in the art and include, for example, DURAMAX® brand binders available from Rohm and Haas Company, Philadelphia, Pa.

The green body also preferably includes one or more plasticizers, such as a polyethylene glycol (e.g., a polyethylene glycol having a molecular weight in the range of about 200 to about 20,000, preferably in the range of about 200 to about 1500), in an amount in the range of about 0.5 to about 2% by weight, based on the weight of the green body, more preferably about 0.8 to about 1% by weight. Preferably, the plasticizer is polyethylene glycol having a weight average molecular weight of about 200 (PEG-200).

Surfactants and dispersants, preferably non-ionic or ammonium salts of anionic surfactants and dispersants, can be added to aid in the grinding of the metal oxide powder mixture prior to calcining, or the calcined powder prior to sintering. A lubricant, such as magnesium stearate, can also be added to the green body, as is known in the art.

After discharge from the die or mold, the green body is sintered to reduce the void space between the particles and form a strong, solid, ceramic material. Preferably, the green body is sintered at a temperature in the range of about 1300 to about 1500° C., taking care to remain at a temperature below the melting point of the mixture. More preferably, the green body is sintered at a temperature in the range of about 1350 to about 1450° C., by heating the green body in a furnace under an oxidizing atmosphere, preferably an air atmosphere.

Preferably, the green body is placed in a cold furnace and the temperature is raised at a rate in the range of about 2 to about 10° C. per minute until a burn-off temperature of at least about 500° C., preferably in the range of about 500 to about 600° C., is obtained. The green body preferably is held at the burn-off temperature for a time period in the range of about 1 to about 2 hours to burn off organic materials in the green body such as binders, plasticizers, dispersants, lubricants, and the like. The temperature is then increased at a rate in the range of about 2 to about 10° C. per minute, and the material is held at a sintering temperature in the range of about 1300 to about 1500° C., preferably in the range of about 1350 to about 1450° C., for a time period in the range of about 2 to about 6 hours. More preferably, the material is held at the sintering temperature for a time period in the range of about 3 to about 5 hours, most preferably about 4 hours.

The following examples are provided to further illustrate the principles of the invention and are not intended to limit the invention to the preferred embodiments disclosed herein.

Raw Materials, Processing Methods, and Analytical Methods.

Alumina (about 99.8% purity) was obtained from Alcan Inc., Montreal, Quebec, Canada; titanium dioxide (about 99.9% purity) was obtained from Ishihara Sangyo Kaisha, Ltd., Osaka, Japan; diniobium pentoxide (about99.8% purity) was obtained from H. C. Stark, Inc., New York, N.Y.; barium zirconate (about 99% purity) was obtained from Ferro Corp., Cleveland, Ohio; dimanganese trioxide (about 98% purity) was obtained from Alpha Aesar, Ward Hill, Mass.; zinc 20 oxide (about 99.8% purity) and nickel oxide (about 99.0% purity) were obtained from T. J. Baker, Phillipsburg, N.J.

The resonant frequency, dielectric constant (K) and the quality factor, Q, of each ceramic material was measured by the well-known Hakki-Coleman method, as described, for example, by Hakki and Coleman, “A Dielectric Method of Measuring Inductive Capacities in the Millimeter Range” IRE Transactions on Microwave Theory and Techniques, July, 1960, pp. 402-409. The resonant frequency used for the measurements fell in the range of about 3.9 GHz to about 5.3 GHz. The T_{f} of each material was measured directly at temperatures between about −40° C. to about +85° C. using Hakki-Coleman parallel plates in a Sun System oven with calculations performed by LabView computer software. The frequency*quality factor, Qf, was calculated by multiplying the Q value by the resonant frequency (in GHz).

### EXAMPLE 1

### Preparation of a Metal Oxide Powder Composition of the Present Invention

About 187 grams of Al₂O₃, about 13 grams of TiO₂, about 0.60 grams of Nb₂O₅, about 1.00 grams of BaZrO₃, about 0.16 grams of Mn₂O₃, about 0.50 grams of NiO, and about 0.50 grams of ZnO were weighed out and mixed together in a ball mill jar (about 0.3 gallon size and mixed with about 200 grams of deionized water containing about 0.3% by weight TAMOL® 963 dispersant. About 50-55 volume percent of zirconia grinding medium (about 0.25 to about 0.5 inch diameter) was added to the jar and the mixture was milled for about 6 hours. Alumina grinding medium can be used in place of the zirconia medium, if desired. The ball mill was stopped and about 5% by weight of PVA binder was added, based on the weight of the metal oxide powders, along with about 0.8% by weight of PEG-200 as a plasticizer. Milling was resumed for about 15 minutes to mix the binder and plasticizer with the powdered metal oxides. The slurry was then poured into a pan and dried overnight at about 120° C. The resultant mixture of metal oxides, binder, plasticizer and dispersant was crushed with a mortar and passed though a 60 mesh sieve to afford a metal oxide powder composition of the invention (P-1).

The metal oxide powder compositions P-2 through P-30 in Table 1, below, were prepared by the procedure described in Example 1 for Powder composition P-1. None of these powder compositions were calcined. In Table 1, the percentage of binder, plasticizer, and dispersant have been omitted, and the weight percentages given are based on the total weight of the metal oxides. In each case, the amounts of binder (PVA), plasticizer (PEG-200, and dispersant (TAMOL® 963 dispersant) were substantially the same as for powder composition P-1. Powder composition P-30 was prepared from an aluminum oxide powder which had a median particle size of about 0.2 to about 0.25 μm; in all other cases, the powder compositions were prepared from aluminum oxide having a median particle size of about 0.45 μm.

TABLE 1
Metal Oxide Mixture Compositions (Weight %)

| | Metal Oxide Wt %: | | | | | | |
|---|---|---|---|---|---|---|---|
| | Al₂O₃ | TiO₂ | Nb₂O₅ | BaZrO₃ | Mn₂O₃ | NiO | ZnO |
| P-1, P-7 | 92.23 | 6.41 | 0.30 | 0.49 | 0.08 | 0.25 | 0.25 |
| P-2, P-4 | 92.23 | 6.41 | 0.30 | 0.99 | 0.08 | 0.00 | 0.00 |
| P-3 | 92.68 | 6.44 | 0.30 | 0.50 | 0.08 | 0.00 | 0.00 |
| P-5 | 93.50 | 5.97 | 0.30 | 0.15 | 0.08 | 0.00 | 0.00 |
| P-6 | 93.37 | 5.96 | 0.30 | 0.30 | 0.08 | 0.00 | 0.00 |
| P-8, P-9 | 91.96 | 6.39 | 0.30 | 0.49 | 0.08 | 0.30 | 0.49 |
| P-10, P-11, | 92.50 | 6.43 | 0.30 | 0.49 | 0.08 | 0.10 | 0.10 |
| P-12 | | | | | | | |
| P-13 | 92.30 | 6.42 | 0.30 | 0.49 | 0.10 | 0.20 | 0.20 |
| P-14 | 91.85 | 6.39 | 0.29 | 0.49 | 0.39 | 0.49 | 0.10 |
| P-15, P-16, | 92.00 | 6.40 | 0.30 | 0.49 | 0.08 | 0.00 | 0.74 |
| P-17 | | | | | | | |
| P-18, P-19 | 92.21 | 6.41 | 0.30 | 0.49 | 0.10 | 0.39 | 0.10 |
| P-20, P-21 | 91.00 | 6.33 | 0.29 | 0.49 | 0.19 | 0.97 | 0.73 |
| P-22 | 90.01 | 6.26 | 0.29 | 0.48 | 0.08 | 0.96 | 1.93 |
| P-23 | 90.76 | 6.31 | 0.29 | 0.49 | 0.21 | 0.97 | 0.97 |
| P-24, P-25 | 92.12 | 6.40 | 0.30 | 0.49 | 0.10 | 0.39 | 0.20 |
| P-26 | 92.15 | 6.41 | 0.30 | 0.99 | 0.16 | 0.00 | 0.00 |
| P-27 | 92.23 | 6.41 | 0.30 | 0.49 | 0.08 | 0.49 | 0.00 |
| P-28 | 92.59 | 6.44 | 0.30 | 0.50 | 0.18 | 0.00 | 0.00 |
| P-29 | 93.27 | 5.95 | 0.30 | 0.15 | 0.08 | 0.00 | 0.25 |
| P-30 | 92.19 | 6.41 | 0.30 | 0.49 | 0.12 | 0.25 | 0.25 |

### EXAMPLE 2

### Preparation of a Calcined Metal Oxide Powder Composition of the Present Invention

Additionally, in a separate procedure, samples of powder compositions having formulations substantially the same as P-13 and P-30 were calcined at 1200° C. for 4 hours and ball milled for 4 hours as a 50% slurry in deionized water containing 0.3% by weight TAMOL® 963 dispersant. After ball milling, the slurries were dried as described in Example 1 for powder composition P-1 and were passed through 60 mesh sieves to afford calcined powders CP-1 and CP-2, respectively.

### EXAMPLE 3

### Preparation of Ceramic Composition CC-1 of the Present Invention

A green body was formed from the non-calcined powder composition P-1 of Example 1 by placing about 25 grams of the powder in a tungsten carbide cylindrically-shaped die having a diameter of about 1.1 inches, placing a cylindrical plunger, sized to fit within the cylindrical cavity of the die, into the upper open end of the die over the powder, and applying a force of about 15 to about 20 tons to the plunger in a hydraulic press to compress the powder into a green body. The pressure was applied for about 10 seconds. The green body was discharged from the die cavity and had a cylindrical shape, with a diameter of about 1.1 inches and a height of about 0.5 inches. The green body had a density of about 2.17 grams per cubic centimeter (g/cm³). A number of substantially identical green bodies were made in this way.

The green bodies were then placed in a furnace at room temperature, and the temperature was raised at a rate of about 2 to about 10° C. up to a set point of about 600° C., and held at this temperature for about 1 hour to substantially burn off the organic binder, dispersant and plasticizer. The temperature was then increased at a rate of about 2 to about 5° C. per minute up to a sintering temperature of about 1402° C. and held at this temperature for about 4 hours. The sintering was accomplished in an air atmosphere. The fuel supply for the furnace was then cut off and the furnace and its contents were allowed to cool to about 50° C. before discharging the resultant ceramic material (ceramic composition CC-1) from the furnace.

The electromagnetic properties of the ceramic material were tested as described above, and the results were as follows: K was about 11.92, Q was about 10,297, Qf was about 52,229,f was about 5.07 GHz, T_{f} was about −1.9 ppm, and the fired density (FD) was about 3.860 g/cm³.

### EXAMPLE 4

### Ceramic Compositions CC-2 through CC-30,,CCC-1 and CCC-2

Ceramic compositions CC-2 through CC-30 of the present invention were prepared from non-calcined powder compositions P-2 through P-30, respectively, according to the method described for the preparation of CC-1, in Example 3, but at the sintering temperature listed in Table 3. Ceramic discs from each of the powder compositions were prepared by the procedure used for ceramic composition CC-1 in Example 3. In each case, the number designation of the ceramic composition (i.e., CC-1, CC-2, etc.) directly corresponds with the number designation of the powder composition from which the ceramic composition was prepared (i.e., CC-1 was prepared from P-1, CC-2 was prepared from P-2, etc.). The calculated elemental compositions of each ceramic material are provided in Table 2, below. Each elemental composition was calculated based on the percentages of each oxide in the powdered metal oxide mixture used to prepare the ceramic composition. Ceramic compositions CCC-1 and CCC-2 in Tables 2 and 3 were prepared from calcined powders CP-1 and CP-2, respectively, also by the method described in Example 3. The measured values for f, Q, Qf, T_{f}, K, and the density after sintering (fired density, FD, in grams per cubic centimeter, g/cc), as well as the sintering temperature for each ceramic composition, are provided in Table 3, below.

TABLE 2
Calculated Elemental Compositions of Ceramic Materials

| | Element %: | | | | | | | |
|---|---|---|---|---|---|---|---|---|
| | Al | Ti | Nb | Ba | Zr | Mn | Ni | Zn |
| CC-1, CC-7 | 48.81 | 3.84 | 0.207 | 0.245 | 0.163 | 0.055 | 0.194 | 0.198 |
| CC-2, CC-4 | 48.81 | 3.84 | 0.207 | 0.490 | 0.325 | 0.055 | 0.000 | 0.000 |
| CC-3 | 49.05 | 3.86 | 0.208 | 0.246 | 0.164 | 0.055 | 0.000 | 0.000 |
| CC-5 | 49.49 | 3.58 | 0.209 | 0.074 | 0.049 | 0.055 | 0.000 | 0.000 |
| CC-6 | 49.41 | 3.57 | 0.208 | 0.148 | 0.098 | 0.055 | 0.000 | 0.000 |
| CC-8, CC-9 | 48.67 | 3.83 | 0.206 | 0.244 | 0.162 | 0.055 | 0.232 | 0.395 |
| CC-10, CC-11, | 48.95 | 3.86 | 0.207 | 0.246 | 0.163 | 0.055 | 0.078 | 0.079 |
| CC-12 | | | | | | | | |
| CC-13 | 48.85 | 3.85 | 0.207 | 0.245 | 0.163 | 0.069 | 0.155 | 0.159 |
| CC-14 | 48.61 | 3.83 | 0.206 | 0.244 | 0.162 | 0.273 | 0.386 | 0.079 |
| CC-15, CC-16, | 48.69 | 3.83 | 0.206 | 0.244 | 0.162 | 0.055 | 0.000 | 0.593 |
| CC-17 | | | | | | | | |
| CC-18, CC-19 | 48.80 | 3.84 | 0.207 | 0.245 | 0.163 | 0.069 | 0.310 | 0.079 |
| CC-20, CC-21 | 48.16 | 3.79 | 0.204 | 0.242 | 0.161 | 0.135 | 0.765 | 0.586 |
| CC-22 | 47.63 | 3.75 | 0.202 | 0.239 | 0.159 | 0.054 | 0.756 | 1.547 |
| CC-23 | 48.03 | 3.78 | 0.204 | 0.241 | 0.160 | 0.149 | 0.763 | 0.780 |
| CC-24, CC-25 | 48.75 | 3.84 | 0.207 | 0.245 | 0.163 | 0.069 | 0.310 | 0.158 |
| CC-26 | 48.77 | 3.84 | 0.207 | 0.489 | 0.325 | 0.110 | 0.000 | 0.000 |
| CC-27 | 48.81 | 3.84 | 0.207 | 0.245 | 0.163 | 0.055 | 0.388 | 0.000 |
| CC-28 | 49.00 | 3.86 | 0.208 | 0.246 | 0.163 | 0.124 | 0.000 | 0.000 |
| CC-29 | 49.36 | 3.57 | 0.208 | 0.074 | 0.049 | 0.055 | 0.000 | 0.199 |
| CC-30 | 48.79 | 3.84 | 0.207 | 0.245 | 0.163 | 0.082 | 0.194 | 0.198 |
| CCC-1 | 48.85 | 3.85 | 0.207 | 0.245 | 0.163 | 0.069 | 0.155 | 0.159 |
| CCC-2 | 48.79 | 3.84 | 0.207 | 0.245 | 0.163 | 0.082 | 0.194 | 0.198 |

TABLE 3
Properties of the Ceramic Compositions

| | Properties: | | | | | | |
|---|---|---|---|---|---|---|---|
| | Ts (C.) | FD | K | Q | f(GHz) | Qf | Tf, ppm/C. |
| CC-1 | 1402 | 3.86 | 11.92 | 10297 | 5.07 | 52226 | −1.9 |
| CC-2 | 1377 | 3.91 | 12.02 | 6833 | 3.91 | 26717 | −5.6 |
| CC-3 | 1377 | 3.90 | 11.95 | 11463 | 3.91 | 44820 | −3 |
| CC-4 | 1377 | 3.92 | 12.00 | 6833 | 3.91 | 26717 | −5.6 |
| CC-5 | 1377 | 3.86 | 11.63 | 12061 | 3.95 | 47641 | −8.3 |
| CC-6 | 1377 | 3.92 | 11.74 | 10730 | 3.94 | 42276 | −7.2 |
| CC-7 | 1377 | 3.92 | 12.08 | 12577 | 5.18 | 65161 | na |
| CC-8 | 1402 | 3.88 | 12.05 | 6895 | 5.14 | 35421 | −2 |
| CC-9 | 1443 | 3.87 | 12.12 | 9504 | 5.02 | 47747 | 4.6 |
| CC-10 | 1402 | 3.86 | 11.68 | 11495 | 5.11 | 58763 | −2.1 |
| CC-11 | 1375 | 3.88 | 12.02 | 8863 | 5.04 | 44698 | −4.2 |
| CC-12 | 1443 | 3.86 | 11.90 | 10511 | 5.17 | 54342 | 1.5 |
| CC-13 | 1402 | 3.86 | 11.97 | 11481 | 5.13 | 58838 | 4.2 |
| CC-14 | 1402 | 3.91 | 12.29 | 5669 | 5.08 | 28769 | 10.3 |
| CC-15 | 1402 | 3.87 | 12.02 | 14026 | 4.87 | 68364 | 1 |
| CC-16 | 1375 | 3.82 | 11.66 | 14143 | 5.10 | 72073 | −4.6 |
| CC-17 | 1443 | 3.91 | 11.74 | 16852 | 5.17 | 87126 | −14 |
| CC-18 | 1402 | 3.89 | 11.95 | 8397 | 5.12 | 42976 | −1.8 |
| CC-19 | 1443 | 3.89 | 12.07 | 8982 | 5.17 | 46448 | 8.8 |
| CC-20 | 1402 | 3.90 | 11.91 | 11204 | 5.03 | 56365 | −2.44 |
| CC-21 | 1443 | 3.90 | 11.92 | 9384 | 5.12 | 48083 | 4.1 |
| CC-22 | 1402 | 3.89 | 11.44 | 10893 | 5.13 | 55925 | −18.4 |
| CC-23 | 1402 | 3.91 | 12.00 | 5690 | 5.11 | 29082 | 1.9 |
| CC-24 | 1402 | 3.89 | 12.00 | 7807 | 5.12 | 40003 | 1 |
| CC-25 | 1375 | 3.89 | 11.97 | 9237 | 4.97 | 45908 | −4.8 |
| CC-26 | 1377 | 3.92 | 12.15 | 8428 | 4.27 | 35945 | −1.2 |
| CC-27 | 1377 | 3.90 | 11.96 | 13525 | 5.16 | 69789 | −10.3 |
| CC-28 | 1377 | 3.79 | 12.01 | 7028 | 5.19 | 36447 | 2.5 |
| CC-29 | 1377 | 3.83 | 11.24 | 4395 | 5.34 | 23482 | na |
| CC-30 | 1443 | 3.90 | 12.17 | 13474 | 5.05 | 67994 | 7.6 |
| CCC-1 | 1402 | 3.85 | 12.05 | 6831 | 5.16 | 35233 | 9.6 |
| CCC-2 | 1443 | 3.87 | 12.50 | 5890 | 4.98 | 29326 | 18.1 |

As the data in Table 3 indicate, the ceramic compositions CC-1 through CC-30, CCC-1 and CCC-2 of the present have temperature coefficients of resonant frequency (T_{f}) values of about 18 ppm or less (absolute value), dielectric constants (K) in the range of about 11 to about 12.3, resonant frequencies (t) in the range of about 3.91 to about 5.3 GHz, and quality factors (Q) values in the range of about 4395 to about 16800. It appears from the data that calcining the metal oxide powder leads to acceptable properties, but provides somewhat lower Q values and somewhat higher T_{f} values when compared to a ceramic of the same elemental composition, but prepared from a non-calcined powder (i.e., compare, CCC-1 with CC-13 and CCC-2 with CC-30).

Numerous variations and modifications of the embodiments described above may be effected without departing from the spirit and scope of the novel features of the invention. No limitations with respect to the specific embodiments illustrated herein are intended or should be inferred.

We claim:

1. A multiphase metal oxide dielectric ceramic composition comprising, on an elemental weight basis:
about 42 to about 50% aluminum;
about 2.5 to about 6% titanium;
about 0.05 to about 1.5% niobium;
about 0.04 to about 1% barium;
about 0.03 to about 0.7% zirconium;
about 0.01 to about 0.3% manganese;
up to about 2.5% nickel; and
up to about 4% zinc;
wherein the aluminum and titanium are present in the composition in an elemental weight ratio of Al:Ti in the range of about 8:1 to about 17:1.

2. A dielectric ceramic composition in accordance with claim 1 comprising at least about 0.05% nickel on an elemental weight basis.

3. A dielectric ceramic composition in accordance with claim 1 comprising at least about 0.05% zinc on an elemental weight basis.

4. A dielectric ceramic composition in accordance with claim 1 comprising about 0.05 to about 2% nickel on an elemental weight basis.

5. A dielectric ceramic composition in accordance with claim 4 comprising about 0.05 to about 3% zinc on an elemental weight basis.

6. A dielectric ceramic composition in accordance with claim 1 wherein the aluminum and titanium are present in the composition in an elemental weight ratio of Al:Ti in the range of about 12:1 to about 14:1.

7. A dielectric ceramic composition in accordance with claim 1 having a dielectric constant, K, in the range of about 10 to about 15.

8. A dielectric ceramic composition in accordance with claim 1 having a quality factor, Q, of at least about 4000 at a resonant frequency in the range of about 2.4 to about 6 GHz.

9. A dielectric ceramic composition in accordance with claim 1 having a temperature coefficient of resonant frequency, T_{f}, in the range of about −20 ppm to about +20 ppm.

10. A dielectric ceramic composition in accordance with claim 1 having a fired density in the range of about 3.7 to about 3.98 grams per cubic centimeter.

11. A multiphase metal oxide dielectric ceramic composition comprising, on an elemental weight basis:
about 47 to about 50% aluminum;
about 3 to about 4.5% titanium;
about 0.1 to about 0.5% niobium;
about 0.05 to about 0.6% barium;
about 0.04 to about 0.4% zirconium;
about 0.05 to about 0.3% manganese;
up to about 1% nickel; and
up to about 2% zinc;
wherein the aluminum and titanium are present in the composition in an elemental weight ratio of Al:Ti in the range of about 12:1 to about 14:1.

12. A metal oxide powder composition suitable for preparation of a dielectric ceramic composition of claim 1, which comprises, on a weight basis:
about 80 to about 95% Al₂O₃;
about 4 to about 10% TiO₂;
about 0.1 to about 2% Nb₂O₅;
about 0.1 to about 2% BaZrO₃;
about 0.01 to about 0.4% Mn₂O₃;
up to about 3% NiO; and
up to about 5% ZnO;
wherein the Al₂O₃ and the TiO₂ are present in the composition in a weight ratio of Al₂O₃:TiO₂ in the range of about 9:1 to about 19:1.

13. A composition in accordance with claim 12 comprising at least about 0.1% NiO on a weight basis.

14. A composition in accordance with claim 12 comprising at least about 0.1% ZnO on a weight basis.

15. A composition in accordance with claim 12 comprising about 0.1 to about 2% NiO on a weight basis.

16. A composition in accordance with claim 12 comprising about 0.1 to about 3% ZnO on a weight basis.

17. A composition in accordance with claim 12 wherein the Al₂O₃ and the TiO₂ are present in the composition in a weight ratio of Al₂O₃:TiO₂ in the range of about 14:1 to about 16:1.

18. A composition in accordance with claim 12 wherein the Al₂O₃ has a median particle size in the range of about 0.01 to about 10 μm, as determined by laser particle size analysis.

19. A composition in accordance with claim 12 which has been calcined at a temperature in the range of about 1000 to about 1250° C. for a time period in the range of about 2 to about 6 hours, and comminuted to a powder having a median particle size in the range of about 0.01 to about 10 μm, as determined by laser particle size analysis.

20. A composition in accordance with claim 12 further comprising at least one additive selected from the group consisting of a dispersant, a binder, a surfactant, a plasticizer, and a lubricant.

21. A metal oxide powder composition suitable for preparation of a dielectric ceramic composition of claim 1, which comprises, on a weight basis:
about 85 to about 94% Al₂O₃;
about 5 to about 7% TiO₂;
about 0.25 to about 0.35% Nb₂O₅;
about 0.1 to about 1% BaZrO₃;
about 0.05 to about 0.4% Mn₂O₃;
up to about 2% NiO; and
up to about 3% ZnO;
wherein the Al₂O₃ and the TiO₂ are present in the composition in a weight ratio of Al₂O₃:TiO₂ in the range of about 12:1 to about 18:1.

22. A composition in accordance with claim 21 further comprising at least one additive selected from the group consisting of a dispersing agent, a binder, a surfactant, a plasticizer, and a lubricant.

23. A method of manufacturing a multiphase metal oxide dielectric 30 ceramic composition having a temperature coefficient of resonant frequency, T_{f}, in the range of about −20 ppm to about +20 ppm, a resonant frequency in the range of about 2.4 to about 6 GHz, a Q value of at least about 4000, and a dielectric constant, K, in the range of about 10 to about 15, the method comprising the steps of:
forming a green body from a co-mixture of a binder and a finely divided, substantially homogeneous metal oxide powder composition comprising, on a weight basis, about 80 to about 95% Al₂O₃, about 4 to about 10% TiO₂, about 0.1 to about 2% Nb₂O₅, about 0.1 to about 2% BaZrO₃, about 0.01 to about 0.4% Mn₂O₃, up to about 3% NiO, and up to about 5% ZnO, wherein the Al₂O₃ and the TiO₂ are present in the composition in a weight ratio of Al₂O₃:TiO₂ in the range of about 9:1 to about 19:1;
sintering the green body at a temperature in the range of about 1300 to about 1500° C., for a time period in the range of about 3 to about 5 hours to form a ceramic material; and
gradually cooling the resultant ceramic material.

24. The method of claim 23 wherein the metal oxide powder composition comprises at least about 0.05% NiO on a weight basis.

25. The method of claim 23 wherein the metal oxide powder composition comprises at least about 0.05% ZnO on a weight basis.

26. The method of claim 23 wherein the metal oxide powder composition comprises about 0.05 to about 2% NiO on a weight basis.

27. The method of claim 23 wherein the metal oxide powder composition comprises about 0.05 to about 3% ZnO on a weight basis.

28. The method of claim 23 wherein the Al₂O₃ and the TiO₂ are present in the metal oxide powder composition in a weight ratio of Al₂O₃:TiO₂ in the range of about 12:1 to about 18:1.

29. The method of claim 23 including, prior to forming the green body, the steps of calcining the metal oxide powder mixture at a temperature in the range of about 1000 to about 1250° C. for a time period in the range of about 2 to about 6 hours, and comminuting the resultant calcined mixture, if necessary, so that the calcined mixture has a median particle size in the range of about 0.01 to about 10 μm, as determined by laser particle size analysis.

30. The method of claim 23 wherein the powder composition further comprises at least one additive selected from the group consisting of a dispersing agent, a binder, a surfactant, a plasticizer, and a lubricant.
